(19) United States
(12) Patent Application Publication
(10) Pub. No.: US 2020/0366998 A1
(43) Pub. Date: Nov. 19, 2020

(54) HEARING ENHANCEMENT AND PROTECTION WITH REMOTE CONTROL

(71) Applicant: Robert A. GEIST, Wichita, KS (US)

(72) Inventor: Robert A. GEIST, Wichita, KS (US)

(21) Appl. No.: 16/638,194

(22) PCT Filed: Aug. 11, 2017
(86) PCT No.: PCT/US2017/046603

§ 371 Date: Feb. 11, 2020

(51) Int. Cl. H04R 25/00; H04R 1/10

(52) U.S. Cl. CPC H04R 25/558; H04R 2225/023; H04R 1/1041

(57) ABSTRACT

A hearing control system is provided herein, including at least one control device in communication with at least one ear piece unit, wherein the at least one control device has a power source, at least one wireless transmitter, a control unit, and at least one tactile input device, wherein the at least one tactile input device is manually engaged prior to at least one noise and the at least one control device sends a request signal through the wireless transmitter in response to the manual engagement of the at least one tactile input device. The at least one ear piece unit has at least one microphone, at least one wireless receiver, a power source, an antenna, at least one processor, at least one amplifier, and at least one speaker contained in an ear piece housing. The wireless transmitter sends the request signal to the wireless receiver and the wireless receiver sends the request signal to that at least one processor and the at least one processor processes the request signal and the at least one microphone, that at least one amplifier, and the at least one speaker block the at least one noise.

### TECHNICAL FIELD

The disclosed device relates generally to methods and systems for hearing enhancement and protection, and more particularly, to manually activated hearing control systems for hearing enhancement and protection.

### BACKGROUND

Audio amplification and ear protection devices can be used for a variety of purposes. For example, an audio headset can be used for amplifying sound from a single audio source, thereby allowing the user to listen to the audio source at a desired volume level. Over ear hearing protection can also be used to protect a user's ears from damage in loud environments. For example, when around firearms, working in a noisy place, a construction site, a demolition site, or any other place where loud, harmful noises are known to occur. Many of these conventional means for providing protection from harmful noises require protection devices to be continuously worn and must be removed to hear everything and vice versa. Thus, there exists a need in the art for an improved hearing control system wherein the user has more control over anticipated and sporadic noise levels which are harmful or which a user prefers to avoid.

### SUMMARY

The disclosed hearing control device is a hearing control system for hearing enhancement and protection. The hearing control device affords protection to people exposed to loud, harmful sounds. In one embodiment of the hearing control device, the user manually activates the protective feature of the hearing control device and then manually deactivates the protective feature. In other embodiments, there may be a time-delay mechanism, whereby the at least one ear piece can automatically return to full functionality. In yet another embodiment, the hearing control device can increase or decrease ambient sounds while still blocking out loud, harmful sounds.

Another embodiment of the hearing control system, has at least one control device in communication with at least one ear piece, wherein the at least one control device has a power source, at least one wireless transmitter, a control unit, and at least one tactile input device, wherein the at least one tactile input device is manually engaged prior to at least one noise and the at least one control device sends a request signal through the wireless transmitter in response to the manual engagement of the at least one tactile input device; and wherein the at least one ear piece has at least one microphone, at least one wireless receiver, a power source, an antenna, at least one processor, at least one amplifier, and at least one speaker contained in an ear piece housing; wherein, the wireless transmitter sends the request signal to the wireless receiver and the wireless receiver sends the request signal to the at least one processor; the at least one processor processes the request signal and the at least one microphone, the at least one amplifier, and the at least one speaker block the at least one noise.

### BRIEF DESCRIPTION OF THE DRAWINGS

FIG. 1 illustrates an embodiment of an ear piece and a control unit of the hearing control system.

FIG. 2A illustrates an example embodiment of a control device of the hearing control system seen from a front view.

FIG. 2B illustrates an embodiment of a control device of the hearing control system seen from a rear view.

FIG. 3A illustrates an embodiment of an ear piece seen from a perspective view.

FIG. 3B illustrates an embodiment of the insertion portion of an ear piece seen from a side view.

FIG. 3C illustrates an embodiment of the contents of an ear piece of the hearing control system.

FIG. 3D illustrates an embodiment of an ear piece seen in an operational position.

### DETAILED DESCRIPTION

The following detailed embodiments presented herein are for illustrative purposes. That is, these detailed embodiments are intended to be exemplary of the disclosed hearing control system for the purposes of providing and aiding a person skilled in the pertinent art to readily understand how to make and use of the hearing control system.

Accordingly, the detailed discussion herein of one or more embodiments is not intended, nor is to be construed, to limit the metes and bounds of the patent protection afforded the disclosed hearing control system, in which the scope of patent protection is intended to be defined by the claims and equivalents thereof. Therefore, embodiments not specifically addressed herein, such as adaptations, variations, modifications, and equivalent arrangements, are considered to be implicitly disclosed by the illustrative embodiments and claims described herein and therefore fall within the scope of the disclosed hearing control system.

Further, it should be understood that, although steps of various claimed methods may be shown and described as being in a sequence or temporal order, the steps of any such method are not limited to being carried out in any particular sequence or order, absent an indication otherwise. That is, any claimed method steps are considered capable of being carried out in any sequential combination or permutation order while still falling within the scope of the disclosed hearing control system.

Additionally, it is important to note that each term used herein refers to that which a person skilled in the relevant art would understand such term to mean based on the contextual use of such term herein. To the extent that the meaning of a term used herein, as understood by the person skilled in the relevant art based on the contextual use of such term, differs in any way from any particular dictionary definition of such term, it is intended that the meaning of the term as understood by the person skilled in the relevant art should prevail.

Furthermore, a person skilled in the art of reading the claims of the disclosed hearing control device should understand that “a” and “an” each generally denotes “at least one,” but does not exclude a plurality unless the contextual use dictates otherwise. And that the term “or” denotes “at least one of the items,” but does not exclude a plurality of items of the list.

The hearing control system allows for the protection of a user's hearing when near sources of harmful levels of sound through the rapid compression of the harmful levels of sound on command. For example, the hearing control system may be used in loud environments such as, but not limited to, construction sites, demolition sites, shooting ranges, and/or hunting grounds. In some embodiments, the hearing control system may entirely mute out all sounds of a harmful decibel level upon engagement by the user. In another embodiment, the hearing control system may enhance ambient sound levels. In yet another embodiment, the hearing control system may act to block harmful decibel levels of sound while also enhancing ambient sound levels. In another embodiment, the hearing control system may completely block out all sounds around the user. In such an embodiment, the hearing control system would not allow any sound to pass through to the user and, thus, the user would not be able to hear any sounds from around them. Thus, a user may engage the hearing control system on command to protect their hearing from harmful and damaging sounds.

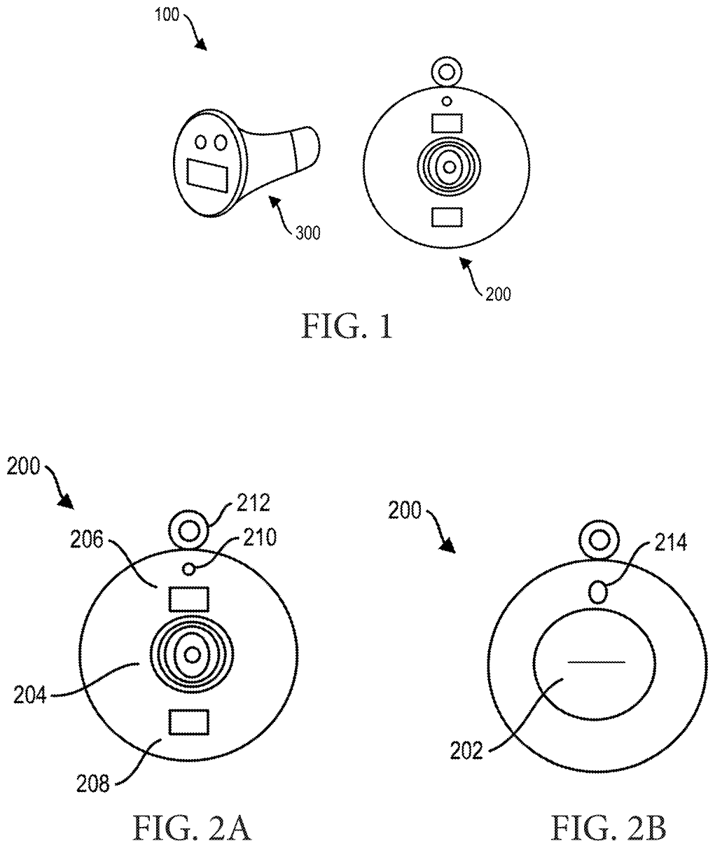

Turing now to FIG. 1. FIG. 1 illustrates an embodiment of an ear piece 300 and a control device 200 of the hearing control system 100. The ear piece 300 and the control device 200 are in wireless communication with one another. Wireless communication is facilitated through at least one wireless transmitter in the control device 200 and at least one wireless receiver in the ear piece 300. In some embodiments, the ear piece 300 and the control unit 200 communicate through a Bluetooth connection.

In use, in some embodiments of the hearing control system 100, the control device 200 sends a signal through the at least one wireless transmitter to the at least one wireless receiver in the ear piece 300. In some embodiments, the control device 200 may send a signal after a tactile input device 204, 206, 208 is engaged. The tactile input device 204 may, in some embodiments be a touch screen. Thus, when the touch screen is engaged, a command is sent from the control device 200 to the ear piece 300 to, for example, mute sounds with a harmful decibel level. In other embodiments, the tactile input device 204 may be, but is not limited to, a depressible sensor, a depressible button, a spring button, a haptic sensor, a switch, a slide, or a knob.

Further, in some embodiments, different modes of sound dampening and compression may be had after engagement of the tactile input device 204. For example, in some embodiments, the sound dampening by the hearing control system 100 is engaged after a user manually activates the sound dampening feature. In some embodiments, the user may manually activate the sound dampening feature by engaging the tactile input device 204. In another embodiment, the user may manually activate the sound dampening feature by voice command. In such an embodiment, the control device 200 may have a microphone to detect a vocal command. Thus, a user may give a voice command to mute harmful decibel levels of sound which then causes the control device 200 to send a signal to the ear piece 300 to begin the process of muting harmful decibel levels of sound while allowing other sounds to still be heard by the user.

In some embodiments, however, the hearing control system may use a combination of both audible commands and the tactile input device 204 to control the sound the user hears. For example, in some embodiments, the ear piece 300, rather than the control device 200, may contain a microphone to detect audible commands. Thus, a user may give verbal commands to mute sounds of a harmful decibel level that are received and acted on by the ear piece 300. This allows the control device 200 to be used to control other aspects of the sound the user hears. For example, in some embodiments, the control device 300 may have at least one tactile input device 204, 206, 208 on the control device 300 to allow for the control the of volume of ambient sounds around the hearing control system 100. Thus, in one embodiment, a control device 300 may have a slider for ambient volume control in one embodiment. In another embodiment, the control device 300 may also have at least one depressible button to control the ambient volume in another embodiment—one depressible button to increase the volume level and another depressible button to decrease the volume level. In yet another embodiment, the tactile input device 204 may be a touch screen with a virtual slider or knob that may be used to control the volume of ambient sounds. In yet another embodiment, the ear piece 200 may receive audible commands to control the volume of ambient sounds the user hears while the control device 300 is used to control the muting of sounds with a harmful decibel level.

In some embodiments, a harmful sound is any sound known to a person of skill in the art to potentially cause damage or discomfort to a person's hearing. For example, in some embodiments, a harmful sound has a decibel level over 85 decibels. In some other embodiments, the harmful sound has a decibel level over 79. In yet another embodiment, the harmful sound has a voltage of 1V.

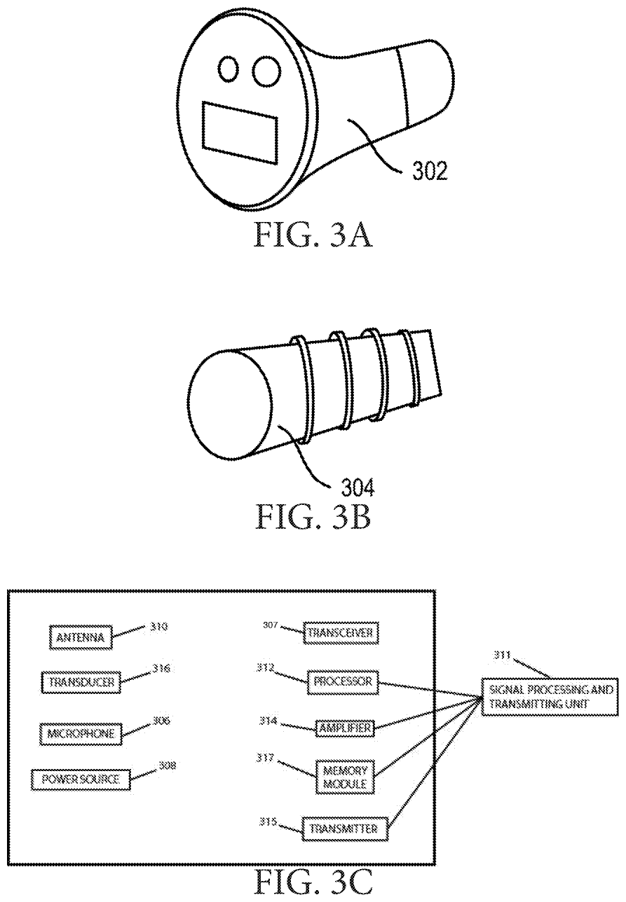

Turning now to FIGS. 2A and 2B. The figures illustrate an embodiment of a control device 300 seen from a front view and a rear view, respectively. In brief, the figures depict the control device 200, a power source 202, a tactile input device 204, 206, 208, a microphone 210, mounting means 212, and a wireless synchronization means 214. In an embodiment, the control device 300 may have a mounting means to be attached to an object or to a user. For example, in some embodiments, the mounting means may be a magnet to facilitate attachment to a firearm. In such an embodiment, the control device 200 may be mounted in a position to allow easy access when using a firearm, for example, but not limited to, proximity to the trigger or in a readily accessible position on the stock of the firearm. Being in proximity to the trigger or a readily accessible position on the stock of the firearm would allow the mute function to be quickly activated prior to firing and deactivated shortly after firing. In another embodiment, the mounting means 212 may be hole to facilitate attachment to a key ring. In yet another embodiment, the mounting means 212 may be a clip. In such an embodiment, the mounting means may be readily attached to a piece of clothing or another easily accessible location. In another embodiment, the mounting means 212 may be a tie down.

The control device 200 may in some embodiments, also have at least one tactile input device 204, 206, 208. The at least one tactile input device 204, 206, 208 is used to send commands to the ear piece 300. For example, in some embodiments, activating the muting function of the hearing control system in some embodiments or controlling the volume of ambient sound. FIG. 2A depicts an example embodiment of a control device 200 having at least one tactile input device 204, 206, 208. The tactile input device 204, 206, 208 may be any input means known to a person of skill in the art. For example, the embodiment shown in FIG. 2A, depicts a control device 200 with a depressible button 204 to engage the muting function of the hearing control system 100 and depressible buttons 206, 208 to control the ambient volume the user hears. In another embodiment, the tactile input devices 204, 206, 208 used to control the muting function and ambient volume may be a haptic sensor. In yet another embodiment, the tactile input devices 204, 206, 208 may be a spring button. In another embodiment, the tactile input devices 204, 206, 208 may be a switch, a slide, or a knob.

In an exemplary embodiment of the present invention, the mute button 204 is mounted in close proximity to trigger of a firearm so that the user can easily and quickly push the mute button 204, pull the trigger, then push the mute button 204 again to unmute the ear piece device 300. Alternately, there could be a time-delay mechanism can be provided, thereby allowing the ear piece device 300 return to full functionality. Further, the mute button 204 may have a special design to be identified by touching the surface of the button 204 or may have a contrast color combination to be identified immediately so as to be pressed as and when required with immediate effect. For example, the mute button 204 in this particular embodiment has a “bulls eye” design and is red in color as shown in the FIG. 2A, however other design and color combination can be used to meet the purpose without departing from the scope and spirit of the present invention.

In yet another embodiment, the front surface of the control device 200 may be replaced with a touch screen to act as the tactile input device 204, 206, 208. In such an embodiment, the touch screen may display a variety of elements for the user to interact with, e.g., a digital button to press to activate the muting function, a digital button to control ambient volume, or a digital slide, knob or switch to control either the muting function or the ambient volume level. Further, the touch screen may display information to the user regarding the hearing control system. For example, in some embodiments, the touch screen may display some of or all of the following: battery life of the control device 200; battery life of the ear piece 300; whether the muting function is active or inactive; how many ear pieces 300 are paired with the control device 200; volume level of the ear piece 300; and decibel level of sound the hearing control system 100 is blocking.

The control device 200, may also have a wireless synchronization means 214 in some embodiments. The wireless synchronization means 214 acts to wireless connect at least one ear piece 300 to the control device 200. In some embodiments, the wireless synchronization means 214 is activated and at least one ear piece 300 is paired with the control device 200. The control device 200 may pair with a plurality of ear pieces 300, for example, when one user is using the hearing control system 100. For the purposes of discussion in this patent, a “set of ear pieces” is defined as a plurality of ear pieces 300. In other embodiments, the control device 200 may be paired with multiple sets of ear pieces 300. Thus, one control device 200 may be paired with at least two sets of ear pieces so that one user can control the muting function for at least one additional person other than the user. Such functionality may be used, for example, at construction sites, shooting ranges, demolition sites, hunting grounds, or any other such place where a harmful sound is known to be eminent to a group of people and protection for the ground of people from the eminent, harmful sound is desired. The wireless synchronization means may, in some embodiments, connect a control device 200 with at least one ear piece 300 through a Bluetooth connection.

The control device 200 also contains a power source 202. FIG. 2B shows an example embodiment of the power source 202. In some embodiments, the power source 202 is a traditional battery. In other embodiments the power source may be a solar cell. In such an embodiment, the solar cell is accompanied by a storage bank to store energy to be used to power the control device 200. In yet another embodiment, the power source 202 may be a rechargeable power source.

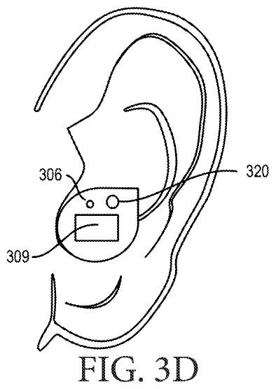

Turning now to FIGS. 3A to 3D. Along with the control device, the hearing control system comprises at least one ear piece 300. Example embodiments of the ear piece 300 are illustrated in FIGS. 3A through 3D. In brief, the figures depict an ear piece housing 302, a snap on multi-finned ear piece 304, a microphone 306, a power source 308, a power source compartment 309, an antenna 310, a processor 312, an amplifier 314, a transducer 316, and a wireless synchronization button 320.

FIG. 3A illustrates an embodiment of an ear piece 300. The ear piece is made up of a front portion and an ear piece housing 302. The front portion of the ear piece may have a power source compartment 309, a voice activated microphone 306, and a wireless synchronization means 320. In some embodiments, the antenna 310, the power source 308, the processor 314, the amplifier 314, and the transducer 316 contained within the ear piece housing 302. In some embodiments, the ear piece housing 302 also acts to create a sound dampening or noise cancelling means when first placed in the user's ear. This is accomplished through sound dampening or noise cancelling systems as known to a person of skill in the art. For example, the ear piece housing 302 may be custom molded to fit and seal a user's ear canal. In other embodiments, the ear piece housing 302 be a variable sized, multi-finned, snap on ear piece housing 304 as illustrated in FIG. 3B. The variable sized, multi-finned, snap on ear piece housing 304 allows the ear piece 300 to comfortably fit in the user's ear as well as provide maximum hearing protection. In another embodiment, the ear piece housing 302 may have a silicone covering or a foam covering to facilitate sealing of the user's ear.

Further, the ear piece housing 302 may contain apertures to allow for the user to hear sounds from the transducers 316 contained within the ear piece housing 302. The apertures may be arranged and placed in ways known to persons of skill in the art. For example, in some embodiments, the apertures are at the distal end of the ear piece housing 302. In some embodiments, the apertures may also be covered with an acoustic mesh or grille. The mesh or grille may act to keep debris from entering the ear piece housing 302. Further, the mesh or grille, in some embodiments, may be soft and made from cloth, weaving, stitching, foam, or fabric upholsteries. A soft mesh or grille has the benefit of being capable of absorbing vibration and they are less prone to rattling. In other embodiments, the mesh or grille may be hard and made from metal, wood, or plastic.

FIG. 3C illustrates an embodiment of the contents of an ear piece. In brief, the figure depicts the components contained within the ear piece housing 302. In some embodiments, those components include a power source 308, a transceiver 307, a signal processing and transmitting unit 311, a transducer 316, and a microphone 306. The signal processing and transmitting unit 311 further contains a processor 312, an amplifier 314, a transmitter 315, and a memory module 317. The microphone 306, memory module 317, transceiver 307, transducer 316 and signal processing and transmitting unit 311 are electrically connected and powered by the power source 308. In some embodiments, the ear piece 300 acts to process sound around the user that is detected. In other embodiments, the ear piece 300 is configured to process sound around the user as well as receive voice commands from a user. Further, the ear piece 300 contains a wireless synchronization means for pairing with the control device 200 or other Bluetooth enabled devices.

In some embodiments, the microphone 306 detects the acoustic signals from the surrounding environment. The microphone 306 may be any microphone known to a person of skill in the art. For example, in some embodiments, the microphone 306 may be an omnidirectional, dynamic frequency response microphone. In other embodiments, the microphone 306 may be a directional microphone. In yet another embodiment, the microphone 306 may be an omnidirectional and directional microphone. The microphone 306 detects the acoustic signals and creates an analog signal. The microphone 306 then converts the analog signal into a digital signal. The transceiver 307 then sends the digital signal to the signal processing and transmitting unit 311. The signal processing and transmitting unit 311 is programmed to process the digital signal received from the microphone 306 and generates one or more reconstructed acoustic signals from the received digital signal. The signal processing and transmitting unit 311 processes the signal through an amplifier 314, processor 312, and memory module 317. In some embodiments, the memory module 317 contains preprogramed instructions necessary to block out harmful sounds. In other embodiments, the memory module 317 may also contain preprogramed instructions necessary to amplify ambient noise.

Once the signal processing and transmitting unit 311 receives the digital signal from the microphone 306, the processor 312 and amplifier 314 are configured to determine whether any portions of the digital signal are harmful decibel levels. For example, in some embodiments, any digital signal over 85 decibels is considered a harmful decibel level. When the signal processing and transmitting unit 311 determines that a digital signal is of a harmful decibel level, the processor 312 and amplifier 314 will not allow the digital signal to pass through to the transducer 316. Thus, a user will not be exposed to harmful noises.

Harmful decibel levels can in one embodiment be pre-programmed into the processor 312. In another embodiment, the harmful decibel level can be determined, programmed, and adjusted by a user via remote programming and adjustment of the processor 312, or by operationally connecting the processor to a user input via, for example, wire transmission. Moreover, in other embodiments, the processor can be configured to have previously programmed and pre-programmed levels stored in the memory module 317, so that a user can enter information which is retained and accessed via, for example, but not limited to, user information, date, type of activity. In this way, more than one user and application for the system is contemplated. Moreover, the harmful decibel level may also be adjusted during use in some embodiments either remotely via Bluetooth, or in other embodiments, manually. In yet other embodiments, the levels can be preprogrammed even by a user to adjust during use.

Once the signal processing and transmitting unit 311 has processed the signals received from the microphone 306, the processed signal will then be transmitted to a transducer 316 if the decibel level of the digital signal is not harmful. The transducer 316 may take the form of any transducer known to a person of skill in the art. For example, in some embodiments, the transducer 316 is a frequency response speaker. In another embodiment, the transducer 316 may be a loudspeaker. In yet another embodiment, the transducer 316 may be a speaker. The transducer 316 acts to convert the electrical, digital signal from the signal processing and transmitting unit 311 into a sound. Thus, the transducer 311 allows the user to hear sounds that are below a harmful decibel level, while blocking out sound of a harmful decibel level.

In some embodiments, the user may engage a tactile input device 204, 206, 208 on the control device 200 to activate the harmful noise cancelling feature of the hearing control system 100. In other embodiments, the user may issue a voice command to activate the harmful noise cancelling feature of the hearing control system. In such an embodiment, the microphone 306 detects an audible command issued prior to at least one noise and the second control unit sends a request signal to the processor 312, thereby the processor 312 processes the request signal and the at least one microphone 306, at least one amplifier 314, and at least one transducer block the at least one noise which is greater than 85 decibels. In some embodiments, the hearing control device 100 may automatically rapidly compress harmful sound if the user neglects to activate the advanced protection function.

While a preferred embodiment of the hearing control system has been described in detail, it should be apparent that modifications and variations thereto are possible, all of which fall within the true spirit and scope of the disclosed hearing control system. With respect to the above description then, it is to be realized that the optimum dimensional relationships for the parts of the disclosed hearing control system, to include variations in size, materials, shape, form, function and manner of operation, assembly and use, are deemed readily apparent to one skilled in the art, and all equivalent relationships to those illustrated in the drawings and described in the specification are intended to be encompassed by the disclosed hearing control system.

Throughout this specification, unless the context requires otherwise, the word “comprise” or variations such as “comprises” or “comprising” or the term “includes” or variations, thereof, or the term “having” or variations thereof will be understood to imply the inclusion of a stated element or integer or group of elements or integers but not the exclusion of any other element or integer or group of elements or integers. In this regard, in construing the claim scope, an embodiment where one or more features is added to any of the claims is to be regarded as within the scope of the disclosed hearing control system given that the essential features of the disclosed hearing control system as claimed are included in such an embodiment.

Those skilled in the art will appreciate that the hearing control system described herein is susceptible to variations and modifications other than those specifically described. It is to be understood that the disclosed hearing control system includes all such variations and modifications that fall within its spirit and scope. The disclosed hearing control system also includes all the steps, features, compositions and compounds referred to or indicated in this specification, individually or collectively, and any and all combinations of any two or more of said steps or features.

Therefore, the foregoing is considered as illustrative only of the principles of the disclosed hearing control system. Further, since numerous modifications and changes will readily occur to those skilled in the art, it is not desired to limit the disclosed hearing control system to the exact construction and operation shown and described, and accordingly, all suitable modifications and equivalents may be resorted to, falling within the scope of the disclosed hearing control system.

What is claimed is:

1. A manually activated hearing control system, comprising:
at least one control device in communication with at least one ear piece, wherein the at least one control device has a power source, at least one wireless transmitter, a control unit, and at least one tactile input device, wherein the at least one tactile input device is manually engaged prior to at least one noise and the at least one control device sends a request signal through the wireless transmitter in response to the manual engagement of the at least one tactile input device; and
the at least one ear piece, wherein the at least one ear piece has at least one microphone, at least one wireless receiver, a power source, an antenna, at least one processor, at least one amplifier, and at least one transducer contained in an ear piece housing,
wherein, the wireless transmitter sends the request signal to the wireless receiver and the wireless receiver sends the request signal to the at least one processor,
the at least one processor processes the request signal and the at least one microphone, the at least one amplifier, and the at least one transducer block the at least one noise.

2. The system of claim 1, wherein the at least one control device has a mounting apparatus selected from the group consisting of a magnet, a hole, a clip, and a tie down.

3. The system of claim 1, wherein the at least one tactile input device is selected from the group consisting of a touch screen, a depressible sensor, a depressible button, a spring button, a haptic sensor, a switch, a slide, and a knob.

4. The system of claim 1, wherein the at least one microphone is voice activated.

5. The system of claim 1, wherein the at least one microphone is an omnidirectional, dynamic frequency response microphone.

6. The system of claim 1, wherein the at least one wireless transmitter is a Bluetooth transmitter.

7. The system of claim 1, wherein the at least one wireless receiver is a Bluetooth receiver.

8. The system of claim 1, wherein the at least one transducer is selected from the group consisting of a frequency response speaker, a loudspeaker, and a speaker.

9. The system of claim 1, wherein the noise is sound waves of greater than 85 decibels.

10. The system of claim 1, wherein the at least one control device has at least one voice activated microphone, the at least one microphone detects an audible command issued prior to the at least one noise and the control unit sends an audible request signal through the at least one wireless transmitter, to the at least one wireless receiver, in response to the issued audible command.

11. A manually activated hearing control system, comprising:
at least one control device in communication with at least one ear piece, wherein the at least one control device has a power source, at least one wireless transmitter, a first control unit, at least one voice activated microphone and at least one tactile input device,
wherein, the first control unit sends an ambient volume request signal through the wireless transmitter after the at least one tactile input device is manually engaged; and
the at least one ear piece, wherein the at least one ear piece has at least one voice activated microphone, at least one wireless receiver, a power source, an antenna, at least one processor, at least one amplifier, a second control unit and at least one transducer contained in an ear piece housing,
wherein, the at least one microphone detects an audible command issued prior to at least one noise and the second control unit sends a request signal to the processor,
the processor thereby processes the request signal and the at least one microphone, at least one amplifier, and at least one transducer block the at least one noise.

12. The system of claim 11, wherein the wireless transmitter sends a request signal after the at least one microphone of the at least one control device detects an audible command issued prior to the at least one noise.

13. The system of claim 11, wherein the tactile input device has a mounting apparatus selected from the group consisting of a magnet, a hole, a clip, and a tie down.

14. The system of claim 11, wherein the at least one tactile input device is selected from the group consisting of a touch screen, a depressible sensor, a depressible button, a spring button, a haptic sensor, a switch, a slide, and a knob.

15. The system of claim 11, wherein the at least one voice activated microphone is an omnidirectional, dynamic frequency response microphone.

16. The system of claim 11, wherein the at least one wireless transmitter is a Bluetooth transmitter.

17. The system of claim 11, wherein the at least one wireless receiver is a Bluetooth receiver.

18. The system of claim 11, wherein the at least one transducer is selected from the group consisting of a frequency response speaker, a loudspeaker, and a speaker.

19. The system of claim 11, wherein the noise is sound waves of greater than 85 decibels.
